(19) United States
(12) Patent Application Publication
(10) Pub. No.: US 2026/0203733 A1
(43) Pub. Date: Jul. 16, 2026

(54) SYSTEMS AND METHODS FOR AUTOMATIC TAX WITHHOLDING IN A DIGITAL PAYMENT NETWORK

(71) Applicant: Wells Fargo Bank, N.A., San Francisco, CA (US)

(72) Inventor: Tosha Wesley Lyles, Charlotte, NC (US)

(21) Appl. No.: 19/022,481

(22) Filed: Jan. 15, 2025

(51) Int. Cl. G06Q 20/10; G06Q 20/20; G06Q 20/40

(52) U.S. Cl. CPC G06Q 20/10; G06Q 20/207; G06Q 20/401

(57) ABSTRACT

Systems, apparatuses, methods, and computer program products are disclosed for automatic tax withholding in a digital payment network. An example method includes receiving a digital transaction request. The example method also includes: determining a purchase amount and a tax amount based on a cost amount identifier; generating a modified digital transaction request based on the purchase amount; authenticating the modified digital transaction request; identifying one or more target recipient accounts based on the modified digital transaction request, and automatically causing, based on the modified digital transaction request, at least one transfer of funds to at least one target recipient account of the one or more target recipient accounts.

### BACKGROUND

Digital payment networks may be used to transfer funds between users. Conventional digital payment systems exhibit numerous drawbacks, inefficiencies, and limitations.

### BRIEF SUMMARY

A digital payment network may provide a service that enables individuals to electronically transfer money from their bank account to another registered user's bank account using a mobile device or a website of a participating banking institution. One example of a digital payment network is Zelle®. Digital payment networks provide advantages over existing peer-to-peer (P2P) payment systems (e.g., Cash App, PayPal, etc.) in that digital payment networks allow for instantaneous transfers of money between two bank accounts and instantaneous access to those funds, whereas transfers in P2P payment systems typically involve a settlement period during which funds are unavailable to a payee for some time (e.g., between one and three days). Some P2P payment systems may require users to pay a fee to reduce or eliminate the settlement period. Additionally, digital payment networks employ data encryption technology to protect users and have a digital infrastructure sponsored by major financial institutions. Because digital payment networks (e.g., Zelle®) transfer funds directly between bank accounts, digital payment networks may be safer option for payments when compared with other online services, such as P2P payment systems, in which funds may be transferred between multiple different platforms before reaching the final recipient.

Operating a small business (e.g., as a startup, sole proprietorship, gig worker, etc.) is a difficult venture due to limited resources. Small businesses may not have certain luxuries larger businesses have, such as personnel, dedicated accounting departments, and the like. Because of this, sales taxes are often tracked manually by small business owners, introducing greater risk of accounting errors due to human errors. Small business owners often face difficulties in properly accounting for sales taxes while conducting business. For instance, across the United States, there are thousands of sales tax jurisdictions, the total number and boundaries of which are constantly changing. This dynamic nature introduces many challenges to small businesses when managing sales taxes.

With the world rapidly transitioning towards a cashless society, many small businesses elect to conduct some, if not all, of their transactions through digital payment networks due to the instantaneous ability to complete transactions. These transactions may mimic cash purchases in that the entire amount of the purchase is separately determined, and the entire payment amount is provided as one lump sum to the business. The portion of the lump sum required to be paid as part of remitting sales taxes must later be sequestered by the small business. In some cases, small business owners may not have accounts specific to their business, which makes distinguishing between taxable sales transactions and non-taxable personal money transfers particularly difficult when conducting business via a digital payment network.

Further, manually tracking sales taxes for transactions conducted over digital payment networks can be time consuming and introduces many pitfalls. Due to inconsistencies in how transactions are typically recorded over a digital payment network (with the only information accompanying most transactions being text recorded in an optional memorandum field), small business owners can face challenges distinguishing business transactions from personal transactions in these contexts. Additionally, as payments via digital payment networks do not produce a receipt or bill of sale for the transaction, retroactively determining precisely which products or services were rendered as a part of a variety of transactions can be extremely challenging if not impossible.

As it is not uncommon for small businesses to conduct business across multiple tax jurisdictions, determining which tax rates apply to and sequestering the correct amount of taxed funds from each purchase adds an additional layer of complexity. Accurate sequestering of funds for the remittance of sales tax for remote purchases conducted via digital payment networks proves difficult as well, as these purchases can occur automatically without the direct involvement of the small business owner or a representative thereof. As such, the business is forced to retroactively sort transactions and sequester taxes manually. Some third-party accounting software options may assist with some of these issues, but these software options are inefficient due to requiring significant legwork on behalf of the small business in terms of training, data entry, and costs, not to mention the potential unwanted exposure of sensitive data through relying on a third-party tool. The prevention of unwanted exposure of sensitive data benefits customers too, as they only need to provide a digital payment network user identifier (e.g., a phone number or email address), limiting the access others may have to payment card information.

In contrast to these conventional tax management techniques, example embodiments described herein solve the foregoing technical problems through a technical solution including automatic tax withholding in a digital payment network. In various embodiments as further described herein, by automating the determination and sequestration of funds into a custodian account for tax purposes, the ability of a business to function efficiently and comply with relevant laws and regulations is improved, while the risk of incurring tax-related penalties is minimized. Further, by integrating this capability into a digital payment network, the business is instantly able to access funds from the purchase without having to wait out a clearing period.

Accordingly, the present disclosure sets forth systems, methods, and apparatuses that allow for the automatic sequestration of tax funds from business transactions conducted via a digital payment network. There are many advantages of these, and other, embodiments described herein. For instance, some embodiments allow for the automated determining of which transactions are subject to sales tax and other tax obligations and automatically sequester tax-related funds on a per transaction basis. Automatically sequestering these funds improves a business' tax compliance. Failing to meet a tax obligation can incur steep fines and other penalties for a business. By ensuring the correct amount of funds are available in a custodian account instantaneously, businesses can react to changing business needs quickly while also being certain their tax needs are met.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for automatic tax withholding in a digital payment network.

FIG. 2A illustrates a schematic block diagram of example circuitry embodying a system device that may perform various operations in accordance with some example embodiments described herein.

FIG. 2B illustrates a schematic block diagram of example circuitry embodying a business device and/or customer device that may perform various operations in accordance with some example embodiments described herein.

FIG. 3 illustrates an example flowchart for automatic tax withholding in a digital payment network, in accordance with some example embodiments described herein.

FIG. 4 illustrates an example flowchart for automatically recording a transaction in a digital ledger and transmitting a receipt to a customer, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessary to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “digital payment network user identifier” refers to a unique identifier that identifies a user of a digital payment network and that is linked to one or more accounts associated with that user. In some examples, a digital payment network user identifier may be a phone number of the user. In some examples, a digital payment network user identifier may be an email address of the user. It is to be appreciated that a digital payment network user identifier may be other unique identifying data for a user, such as a unique username or the like. When a user signs up for a digital payment network (such as Zelle®), they are required to link their account(s) to the digital payment network user identifier, so that the digital payment network user identifier can be used to route payments and verify transactions. By establishing this link, the digital payment network (and associated systems) can accurately associate users with their banking accounts and allow users to send and receive funds without needing to share sensitive financial data (e.g., account numbers, routing numbers, card numbers, etc.) with other parties.

### System Architecture

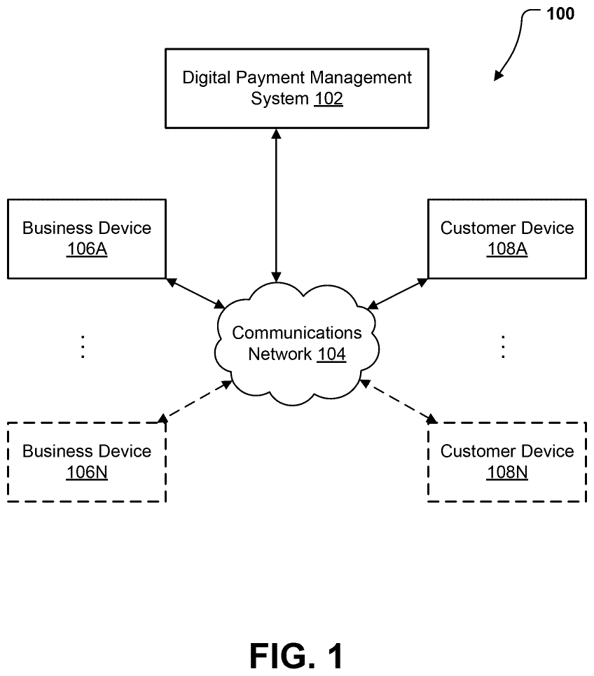

Example embodiments described herein may be implemented using any of a variety of computing devices or servers. To this end, FIG. 1 illustrates an example environment 100 within which various embodiments may operate. As illustrated, a digital payment management system 102 may receive and/or transmit information via communications network 104 (e.g., the Internet) with any number of other devices, such as one or more of business devices 106A-106N and/or customer devices 108A-108N.

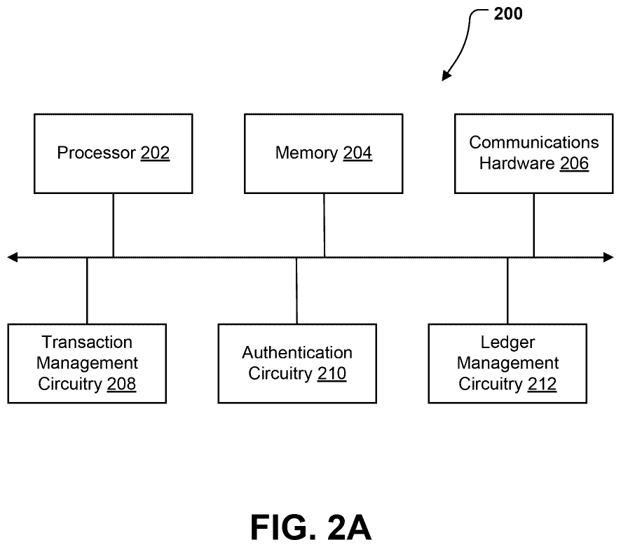

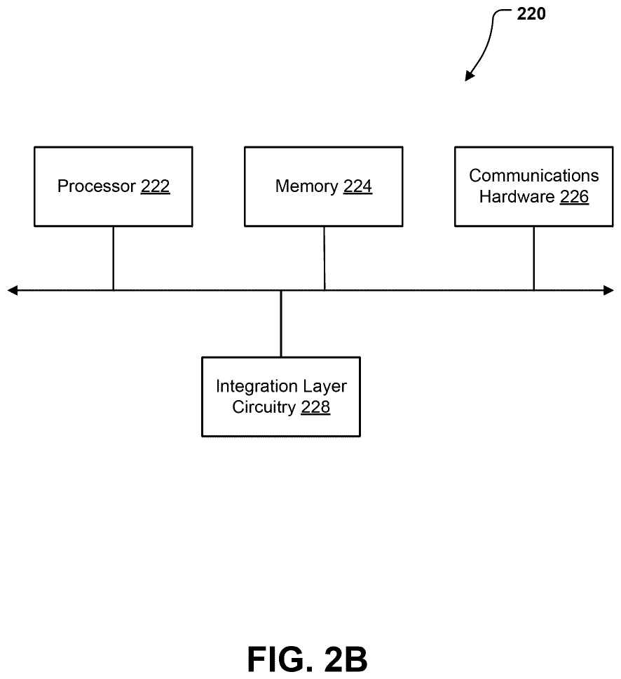

The digital payment management system 102 may be implemented as one or more computing devices or servers, which may be composed of a series of components. Particular components of the digital payment management system 102 are described in greater detail below with reference to apparatus 200 in connection with FIG. 2A.

In some embodiments, the digital payment management system 102 further includes a storage device that comprises a distinct component from other components of the digital payment management system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The storage device may host the software executed to operate the digital payment management system 102. The storage device may store information relied upon during operation of the digital payment management system 102, such as various associations between digital payment network user identifiers that may be used by the digital payment management system 102, data and documents to be analyzed using the digital payment management system 102, or the like. In addition, the storage device may store control signals, device characteristics, and access credentials enabling interaction between the digital payment management system and one or more of the business devices 106A-106N and/or customer devices 108A-108N.

In various embodiments, digital payment management system 102 may be integrated as a component of a digital payment network (e.g., Zelle®) and serve as an additional layer that provides business transaction-specific functionalities, such as automatic tax withholding as further discussed herein. In this manner, the digital payment network may facilitate transfers of funds between individuals and/or businesses, while the digital payment management system 102 may add tailored technical features such as automatic tax withholding and routing, receipt generation, business transaction tracking, and the like as further described herein.

The one or more business devices 106A-106N and the one or more customer devices 108A-108N may be embodied by any computing devices known in the art. The one or more business devices 106A-106N and the one or more customer devices 108A-108N need not themselves be independent devices but may be peripheral devices communicatively coupled to other computing devices. In various embodiments, the one or more business devices 106A-106N and the one or more customer devices 108A-108N may include a software application (e.g., a mobile banking application) which is associated with and facilitates interaction with the digital payment network and digital payment management system 102.

Although FIG. 1 illustrates an environment and implementation in which the digital payment management system 102 interacts indirectly with a user via one or more of business devices 106A-106N and/or customer devices 108A-108N, in some embodiments users may directly interact with the digital payment management system 102 (e.g., via communications hardware of the digital payment management system 102), in which case a separate business device 106A-106N and/or customer device 108A-108N may not be utilized. Whether by way of direct interaction or indirect interaction via another device, a user may communicate with, operate, control, modify, or otherwise interact with the digital payment management system 102 to perform the various functions and achieve the various benefits described herein.

### Example Implementing Apparatuses

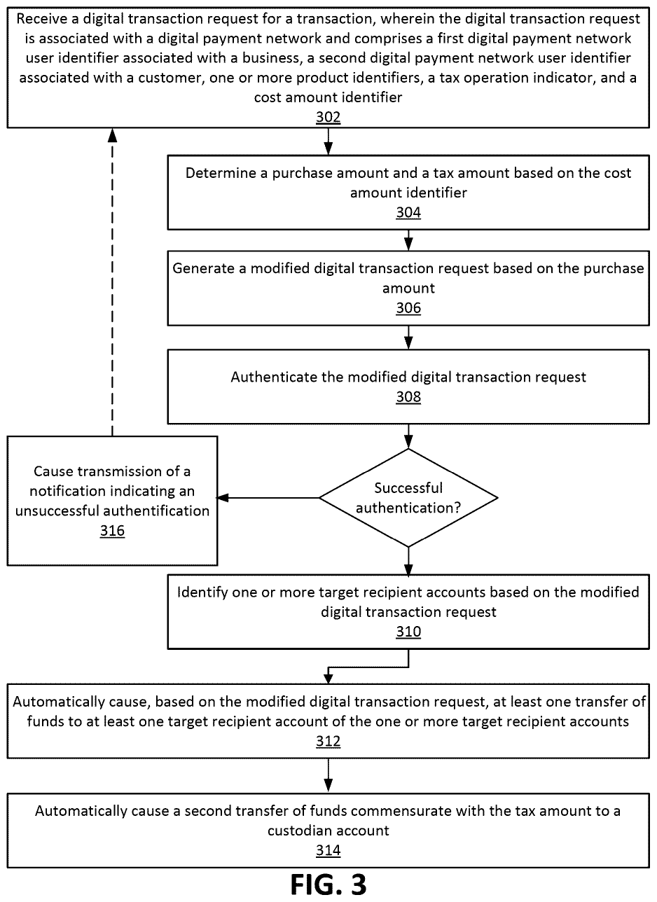

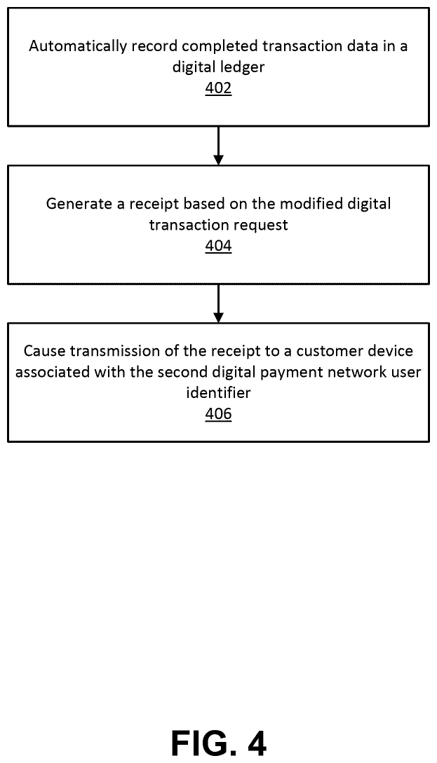

The digital payment management system 102 (described previously with reference to FIG. 1) may be embodied by one or more computing devices or servers, shown as apparatus 200 in FIG. 2A. The apparatus 200 may be configured to execute various operations described above in connection with FIG. 1 and below in connection with FIGS. 3 and 4. As illustrated in FIG. 2A, the apparatus 200 may include processor 202, memory 204, communications hardware 206, transaction management circuitry 208, authentication circuitry 210, and ledger management circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises transaction management circuitry 208 that generates a purchase amount based on a cost amount identifier and a tax amount, generates modified digital transaction request based on the purchase amount, and causes transfer of funds to facilitate the completion of a transaction. The transaction management circuitry 208 may utilize processor 202, memory 204, or any other hardware component included in the apparatus 200 to perform these operations, as described in connection with FIGS. 3 and 4 below. The transaction management circuitry 208 may further utilize communications hardware 206 to gather data from a variety of sources (e.g., business devices 106A-106N and/or customer devices 108A-108N), and/or exchange data with a user.

In addition, the apparatus 200 further comprises an authentication circuitry 210 that authenticates modified digital transaction requests. The authentication circuitry 210 may utilize processor 202, memory 204, or any other hardware component included in the apparatus 200 to perform these operations, as described in connection with FIGS. 3 and 4 below. The authentication circuitry 210 may further utilize communications hardware 206 to gather data from a variety of sources (e.g., business devices 106A-106N and/or customer devices 108A-108N, as shown in FIG. 1), and/or exchange data with a user.

Further, the apparatus 200 further comprises a ledger management circuitry 212 that automatically records completed transaction data in a digital ledger and generates receipts based on modified digital transaction requests. The ledger management circuitry 212 may utilize processor 202, memory 204, or any other hardware component included in the apparatus 200 to perform these operations, as described in connection with FIGS. 3 and 4 below. The ledger management circuitry 212 may further utilize communications hardware 206 to gather data from a variety of sources (e.g., business devices 106A-106N and/or customer devices 108A-108N, as shown in FIG. 1), and/or exchange data with a user.

Although components 202-212 are described in part using functional language, it will be understood that the particular implementations necessarily include the use of particular hardware. It should also be understood that certain of these components 202-212 may include similar or common hardware. For example, the transaction management circuitry 208, authentication circuitry 210, ledger management circuitry 212, may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the transaction management circuitry 208, authentication circuitry 210, and ledger management circuitry 212 may leverage processor 202, memory 204, or communications hardware 206 as described above, it will be understood that any of transaction management circuitry 208, authentication circuitry 210, and ledger management circuitry 212 may include one or more dedicated processors, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that transaction management circuitry 208, authentication circuitry 210, and ledger management circuitry 212 comprise particular machinery designed for performing the functions described herein in connection with such elements of apparatus 200.

As illustrated in FIG. 2B, an apparatus 220 is shown that represents an example business device (e.g., any of business devices 106A-106N) or an example customer device (e.g., any of customer devices 108A-108N). The apparatus 220 includes processing circuitry 222, memory 224, and communications hardware 226, each of which is configured to be similar to the similarly named components described above in connection with FIG. 2A. However, the apparatus 220 also includes integration layer circuitry 228, which may be integrated into a predefined application (e.g., a mobile banking application) and which can retrieve data from one or more applications stored (e.g., in memory 224) on a client device and generate requests (e.g., digital transaction requests) comprising the retrieved data (e.g., digital payment network user identifiers).

In some embodiments, the integration layer circuitry 228 may utilize an Application Programming Interface (API) to connect to one or more applications. For example, the integration layer circuitry 228 may utilize an API to connect to the digital payment management system 102 by leveraging communications hardware 226. The integration layer circuitry 228 may also facilitate transmission of data, such as a credential and a digital payment network user identifier via the API. In some embodiments, the integration layer circuitry 228 may generate a digital transaction request which can then be transmitted to the digital payment management system 102.

In some embodiments, various components of the apparatuses 200 and 220 may be hosted remotely (e.g., by one or more cloud servers) and thus need not physically reside on the corresponding apparatus 200 or 220. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200 or 220. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2A or apparatus 220 as described in FIG. 2B, that loading the software instructions onto a computing device or apparatus produces a special-purpose machine comprising the means for implementing various functions described herein.

Having described specific components of example apparatuses 200 and 220, example embodiments are described below in connection with a series of flowcharts.

### Example Operations

Turning to FIGS. 3 and 4, example flowcharts are illustrated that contain example operations implemented by example embodiments described herein. The operations illustrated in FIGS. 3 and 4 may, for example, be performed by a system device of the digital payment management system 102 shown in FIG. 1, which may in turn be embodied by an apparatus 200, which is shown and described in connection with FIG. 2A, which may communicate with an apparatus 220 which is shown and described in connection with FIG. 2B. To perform the operations described below, the apparatus 200 may utilize one or more of processor 202, memory 204, communications hardware 206, transaction management circuitry 208, authentication circuitry 210, ledger management circuitry 212, and/or any combination thereof. It will be understood that user interaction with the digital payment management system 102 may occur directly via communications hardware 206 or may instead be facilitated by a separate business device 106A-106N and/or customer device 108A-108N, as shown in FIG. 1, and which may have similar or equivalent physical componentry facilitating such user interaction.

Turning first to FIG. 3, example operations are shown for automatic tax withholding in a digital payment network (e.g., Zelle®).

As shown by operation 302, the apparatus 200 includes means, such as processor 202, memory 204, communications hardware 206, or the like, for receiving a digital transaction request for a transaction. In some embodiments, a business device (e.g., business device 106A) or a customer device (e.g., customer device 108A), can generate and transmit a digital transaction request to digital payment management system 102 via communications network 104.

In some embodiments, generation and transmission of a digital transaction request can be initiated by usage of a hyperlink which is accessed by scanning scannable indicia (e.g., a QR-code or barcode). In some embodiments, scanning a form of scannable indicia or using a hyperlink may determine a set of tax-rules for a transaction. For example, upon the scanning of a form of scannable indicia (e.g., a displayed QR-code), digital payment management system 102 may direct a business device (e.g., business device 106A) or a customer device (e.g., customer device 108A) to generate and/or transmit a digital transaction request. In another example, the use of a hyperlink (e.g., clicking, copying) may direct a business device (e.g., business device 106A) or a customer device (e.g., customer device 108A) to generate and/or transmit a digital transaction request. In some embodiments, a customer and a business may be co-located, such as in the case of an in-person transaction at a “brick and mortar” storefront. In some embodiments, a customer and a business entity may be remote from each other, for example in the case of online sales.

In some embodiments, the digital transaction request is associated with a digital payment network and comprises a first digital payment network user identifier associated with a business, a second digital payment network user identifier associated with a customer, one or more product identifiers, a tax operation indicator, and a cost amount identifier. In some embodiments additional information may be included with a digital transaction request such as the location of the business and the customer (e.g., shipping address, billing address). In some embodiments, the digital transaction request may include associated metadata (e.g., geolocation data, biometric data, timestamp data, user-supplied text input, customer identity data, etc.). In some embodiments, product identifiers may be input by choosing selectable indicia, manual entry of a product identifier, scanning some scannable indicia, image analysis of an image associated with or of a product, or through the use of a hyperlink. A product identifier may identify any good or service rendered to as a part of a transaction. In some embodiments, a product identifier may be a data structure which identifies a product which is subject to a transaction according to a digital transaction request. In some embodiments, a product identifier may be an alphanumeric, a character string, or other data structure which may refer to a real or digital product or service which may be sold/purchased as part of a transaction. In some embodiments, a cost amount identifier may be an identifier (e.g., an alphanumeric code, data) which identifies a cost amount associated with a particular product based on the product identifier associated with a particular product. In some embodiments, a cost amount identifier is identified based on a product identifier associated with the digital transaction request. In some embodiments, the digital transaction request may comprise a tax operation indicator which indicates whether the cost amount identifier should be treated as a pre-tax cost amount or a post-tax cost amount. In some embodiments, the tax operation indicator may be a digital flag, a data object or other digital indicator. In some embodiments, when a cost amount is to be treated as a pre-tax cost, the applicable tax amount may be added to the cost amount in a later operation. In some embodiments, when a cost amount is to be treated as post-tax, the purchase amount may not exceed the cost amount in a later operation. In some embodiments, the cost amount identifier identifies the sum of the individual cost of each product as identified through the product identifiers.

As shown by operation 304, the apparatus 200 includes means, such as processor 202, memory 204, communications hardware 206, transaction management circuitry 208, or the like, for determining a purchase amount and a tax amount based on the cost amount identifier. As mentioned above, some small business owners may conduct business using accounts that are also used for non-business purposes or may have a portion of their products/services that are tax-exempt. For these situations, it may be important to automatically determine if and which taxes apply to the transaction.

In some embodiments, the purchase amount corresponds to the total amount of funds which will need to be transferred from a customer to a business in order to complete the purchase of a product. In some embodiments, a tax amount (e.g., applicable sales taxes) may be calculated and applied to the digital transaction request based on the product identifiers, cost amount identifier and associated cost amount, and metadata (e.g., geolocation data, biometric data, timestamp data, user-supplied text input, customer identity data, etc.). In some embodiments, following the determination of the tax amount, and a final total price (i.e., the purchase amount) for the transaction may be determined. In some embodiments, a purchase amount is generated corresponding to the final price to be paid by a customer, such that the purchase amount is the sum of the tax amount and the cost amount as indicated by the cost amount identifier. In some embodiments, the purchase amount may be determined by adding the tax amount and cost amount together, such as in the case of a cost amount designated as pre-tax. In some embodiments, the purchase amount updated to be equal to the cost amount, such as in the case of a cost amount designated as post-tax.

In some embodiments, the applicability of taxes to a particular transaction may be specified as part of a digital transaction request. In some embodiments, upon clicking a link or scanning an image (e.g., a QR code) using a device, digital payment management system 102 may direct to a digital means (e.g., a website) of conducting transactions with a business, such that by using that digital means, sales taxes are determined to apply to a particular transaction. In some embodiments, the tax amount is partly determined based on the use of a hyperlink which may be accessed in a number of ways (e.g., through the use of a hyperlink, through the use of scannable indicia).

In some embodiments, transactions with certain individuals may be determined to be non-taxable or subject to specific tax rules by default based on that particular customer's identity. In some embodiments, the customer's identity may be determined based on the digital payment network user identifier associated with the customer. In some embodiments, the customer's identity may be determined by comparing the digital payment network user identifier, associated with the customer and the digital transaction request, against a database of digital payment network user identifiers and associated user identities. In some embodiments, the digital payment network user identifier is received by payment management system 102 with the digital transaction request. In some embodiments, a database of digital payment network user identifiers and associated user identity information are stored in a memory 204. In some embodiments, the digital payment network user identifier may be entered into a database with associated user identity information when a user enrolls in a digital payment network. In some embodiments, customer identity data may comprise a customer's name, shipping address, billing address, or similar personal or demographic information. In some embodiments, certain products (e.g., many services, some healthcare items) may not have taxes applied to their purchase. In some embodiments, when no taxes are determined to apply, the tax amount may be determined to be zero dollars ($0.00). In some embodiments, the product identifiers may be used to determine the tax amount.

The digital transaction request and metadata may, in some embodiments, be used to determine if taxes apply to a particular transaction, determine which taxes apply to a particular transaction, and calculate the total amount of taxes which must be paid as a result of the transaction. In some embodiments, the tax amount may be based on metadata associated with a digital transaction request (e.g., geolocation data, biometric data, timestamp data, user-supplied text input, and customer identity data, etc.). In some embodiments, metadata associated with the digital transaction request may be used to determine the tax amount. In some embodiments, metadata associated with a digital transaction request may comprise information such as geolocation data, customer identity data, date and time data, etc.

As shown by operation 306, the apparatus 200 includes means, such as processor 202, memory 204, communications hardware 206, transaction management circuitry 208, authentication circuitry 210, or the like, for generating a modified digital transaction request based on the purchase amount. In some embodiments, the modified digital transaction request is able to be inspected with a business device (e.g., business device 106A) or a customer device (e.g., customer device 108A). In some embodiments, the modified digital transaction request may be stored separately from the original digital transaction request. In some embodiments, the modified digital transaction request may overwrite the original digital transaction request either partly or fully. In some embodiments, generating the modified digital transaction request comprises incorporating the purchase amount and tax amount into the original digital transaction request and updating the cost amount, in accordance with the tax operation indicator.

As shown by operation 308, the apparatus 200 includes means, such as processor 202, memory 204, communications hardware 206, transaction management circuitry 208, authentication circuitry 210, or the like, for authenticating the modified digital transaction request. In some embodiments, credential data may be input by a customer and/or a business, which implies the acceptance of the terms of a transaction. In some embodiments, the credential data may be authenticated by comparing the input credential data, input using either a business device (e.g., business device 106A) or a customer device (e.g., customer device 108A), against a set of stored credential data associated with the business' digital payment network user identifier or the customer's digital payment network user identifier. In some embodiments, credential data may comprise a passcode, personal identification number, biometric signature, facial recognition, or fingerprint data which is authenticated by comparing against a database of digital payment network user identifiers and their corresponding authentication metrics. In some embodiments, successful authentication may cause transmission of a signal that authentication was successful to payment management system 102. In the event of an unsuccessful authentication, such as in the case of a mistyped pin or an incorrect biometric reading, the method may progress to operation 316, which is described below.

As shown by operation 310, the apparatus 200 includes means, such as processor 202, memory 204, communications hardware 206, transaction management circuitry 208, or the like, for identifying one or more target recipient accounts based on the modified digital transaction request and in response to a successful authentication at operation 308. In some embodiments, one or more target recipient accounts may be identified by digital payment management system 102 based on the digital payment network user identifier associated with the customer and the digital payment network user identifier associated with the business. In some embodiments, one of the one or more target recipient accounts may be a custodian account designated by the business to be for the receipt and remittance of tax-related funds, with funds related to sales-taxes being of particular importance in some example implementations. In some embodiments, the one or more target recipient accounts may be identified by comparing digital payment network user identifiers against a database of known digital payment network user identifiers and accounts associated therewith.

As shown by operation 312, the apparatus 200 includes means, such as processor 202, memory 204, communications hardware 206, transaction management circuitry 208, or the like, for automatically causing, based on the modified digital transaction request, at least one transfer of funds to at least one target recipient account of the one or more target recipient accounts. In some embodiments, upon receipt of the acceptance of the modified digital transaction request, a first transfer of funds may be commensurate with the purchase amount, such that the tax amount is also included in the total amount of funds transferred from a customer's account. In some embodiments, the first transfer of funds may be commensurate with the difference of the purchase amount and the tax amount, such that the tax amount must be transferred from a customer's account separately.

As shown by operation 314, in some embodiments, the apparatus 200 includes means, such as processor 202, memory 204, communications hardware 206, transaction management circuitry 208, or the like, for automatically causing a second transfer of funds commensurate with the tax amount to a custodian account. In some embodiments, the second transfer of funds is initiated in response to the success of the first transfer of funds. In some embodiments, the custodian account may be the same as another identified account. In some embodiments, the second transfer of funds may be directed from a customer's account. In some embodiments, the second transfer of funds may be directed from a business' non-custodian account to a business' custodian account. In some embodiments, the second transfer of funds may not proceed until the completion of the first transfer of funds. In some embodiments, the second transfer of funds may proceed simultaneously with the first transfer of funds.

Finally, as shown by operation 316, the apparatus 200 includes means, such as processor 202, memory 204, communications hardware 206, transaction management circuitry 208, authentication circuitry 210, or the like, for causing transmission of a notification indicating an unsuccessful authentication. In the event of a failed authentication, a notification may be transmitted back to a business device (e.g., business device 106A) and/or a customer device (e.g., customer device 108A). In some embodiments, this may terminate the method or require the method to be reinitiated from operation 302, as indicated by the dashed line in FIG. 3.

Turning now to FIG. 4, example operations are shown for automatically recording details of completed transactions in a digital ledger and providing receipts to customers following the completion of a transaction. Given the importance of complete and accurate business records, having completed transaction details be automatically recorded in a digital ledger by ledger management circuitry provides small businesses with peace of mind when it comes time to remit taxes from the sale of various products, overcoming the technical limitations introduced when manually recording transactions and tax liabilities. In some embodiments, these records are able to be inspected at any time. In some embodiments, the digital ledger may not be stored in the same location as the business but may be stored in a non-volatile memory device (e.g., memory 204) which is remotely accessed.

As shown by operation 402, the apparatus 200 includes means, such as processor 202, memory 204, communications hardware 206, transaction management circuitry 208, ledger management circuitry 212, or the like, for automatically recording details of a completed transaction in a non-volatile memory device. In some embodiments, a record of completed transactions may be compiled by the digital payment management system 102 and stored in memory 204. In some embodiments, this record may comprise the date of the transfers, the total amount of transferred funds, the reason for the transfers, and the amount of transferred funds which were sent to one or more target recipient accounts. In some embodiments, the recorded details of completed payments stored in the ledger may be readily accessed and inspected at any time, such as in the case of a customer using payment records to provide proof of purchase or for the preparation of tax forms by a business or a representative thereof. In some embodiments, the details of a completed transaction may comprise the date of the transaction, the time of the transaction, the total amount of the transaction, the tax amount of the transaction, and/or any associated metadata.

As shown by operation 404, the apparatus 200 includes means, such as processor 202, memory 204, communications hardware 206, transaction management circuitry 208, ledger management circuitry 212, or the like, for generating a receipt based on the digital transaction request. In some embodiments, the receipt may comprise the date of the transaction, the time of the transaction, the total amount of the transaction, the tax amount of the transaction, or any associated metadata. In some embodiments, a business may select only certain details of the completed transaction to be disclosed on the receipt before the receipt is generated.

As shown by operation 406, the apparatus 200 includes means, such as processor 202, memory 204, communications hardware 206, transaction management circuitry 208, ledger management circuitry 212, or the like, for causing transmission of the receipt to a device associated with the digital payment network user identifier associated with the customer. In some embodiments, the receipt, as transmitted, may be in the form of a text document, an image, a portable document format file, or the like. In some embodiments, the receipt may include hyperlinks to webpages that provide additional details regarding a completed transaction, or products associated with a completed transaction.

FIGS. 3 and 4 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Conclusion

As described above, example embodiments provide methods and apparatuses that enable improved use of digital payment networks for conducting taxable business transactions, particularly in the case of small businesses that lack significant accounting resources. Example embodiments thus provide tools that overcome the problems faced by manual or conventional means of sequestering tax liable funds from payments received from customers via digital payment networks. By automating the determination of tax amounts and automatically transferring funds to a custodian account following a transaction which is subject to taxes, businesses may be more able to avoid penalties associated with failing to properly remit taxes.

As these examples all illustrate, example embodiments contemplated herein provide technical solutions that solve real-world problems faced when conducting business transactions over digital payment networks. While properly determining and sequestering sales taxes for transactions conducted over digital payment networks has been an issue for years, the rapidly growing number of small businesses makes the problem significantly more acute, as the use of digital payment networks for business related transactions has grown significantly even while the complexity of remitting sales and other taxes for transactions conducted over digital payment networks has itself increased due to the constantly changing landscape of sales tax jurisdictions. At the same time, the recently arising ubiquity of digital payment networks has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by communications hardware, a digital transaction request for a transaction, wherein the digital transaction request is associated with a digital payment network and comprises a first digital payment network user identifier associated with a business, a second digital payment network user identifier associated with a customer, one or more product identifiers, a tax operation indicator, and a cost amount identifier;
determining, by transaction management circuitry, a purchase amount and a tax amount based on the cost amount identifier;
generating, by the transaction management circuitry, a modified digital transaction request based on the purchase amount;
authenticating, by authentication circuitry, the modified digital transaction request;
in response to a successful authentication of the modified digital transaction request:
identifying, by the transaction management circuitry, one or more target recipient accounts based on the modified digital transaction request, and
automatically causing, by the transaction management circuitry and based on the modified digital transaction request, at least one transfer of funds to at least one target recipient account of the one or more target recipient accounts.

2. The method of claim 1, wherein automatically causing the at least one transfer of funds comprises:
automatically causing, by the transaction management circuitry, a first transfer of funds to a first target recipient account of the one or more target recipient accounts, and
automatically causing, by the transaction management circuitry, a second transfer of funds commensurate with the tax amount to a custodian account.

3. The method of claim 1, further comprising:
determining, by the transaction management circuitry, the tax amount based on metadata of the digital transaction request.

4. The method of claim 3, wherein the metadata comprises one or more of geolocation data, timestamp data, biometric data, user-supplied text input, and customer identity data.

5. The method of claim 3, wherein the tax amount is determined based on a usage of a hyperlink associated with the digital transaction request.

6. The method of claim 5, wherein the hyperlink is accessed via scannable indicia associated with the digital transaction request.

7. The method of claim 1, wherein determining the purchase amount comprises combining, by the transaction management circuitry, the tax amount and a cost amount indicated by the cost amount identifier such that the purchase amount is equal to a sum of the tax amount and the cost amount.

8. The method of claim 1, further comprising:
automatically recording, by ledger management circuitry, completed transaction data in a digital ledger;
generating, by the ledger management circuitry, a receipt based on the modified digital transaction request; and
causing, by the communications hardware, transmission of the receipt to a customer device associated with the second digital payment network user identifier.

9. The method of claim 1, wherein authenticating the modified digital transaction request comprises:
authenticating, by the authentication circuitry, credential data received from a customer device associated with the second digital payment network user identifier.

10. The method of claim 1, wherein the tax operation indicator identifies the cost amount identifier as identifying a cost amount as one of a pre-tax cost amount or a post-tax cost amount.

11. An apparatus comprising:
communications hardware configured to receive a digital transaction request for a transaction, wherein the digital transaction request is associated with a digital payment network and comprises a first digital payment network user identifier associated with a business, a second digital payment network user identifier associated with a customer, one or more product identifiers, a tax operation indicator, and a cost amount identifier;
transaction management circuitry configured to:
determine a purchase amount and a tax amount based on the cost amount identifier, and
generate a modified digital transaction request based on the purchase amount; and
authentication circuitry configured to authenticate the modified digital transaction request,
wherein the transaction management circuitry is further configured to, in response to a successful authentication of the modified digital transaction request:
identify one or more target recipient accounts based on the modified digital transaction request, and
automatically cause, based on the modified digital transaction request, at least one transfer of funds to at least one target recipient account of the one or more target recipient accounts.

12. The apparatus of claim 11, wherein the transaction management circuitry is configured to automatically cause the at least one transfer of funds by:
automatically causing a first transfer of funds to a first target recipient account of the one or more target recipient accounts, and
automatically causing a second transfer of funds commensurate with the tax amount to a custodian account.

13. The apparatus of claim 11, wherein the transaction management circuitry is further configured to:
determine the tax amount based on metadata of the digital transaction request.

14. The apparatus of claim 13, wherein the metadata comprises one or more of geolocation data, timestamp data, biometric data, user-supplied text input, and customer identity data.

15. The apparatus of claim 13, wherein the tax amount is determined based on a usage of a hyperlink associated with the digital transaction request.

16. The apparatus of claim 15, wherein the hyperlink is accessed via scannable indicia associated with the digital transaction request.

17. The apparatus of claim 11, further comprising:
ledger management circuitry configured to:
automatically record completed transaction data in a digital ledger, and
generate a receipt based on the modified digital transaction request,
wherein the communications hardware is further configured to cause transmission of the receipt to a customer device associated with the second digital payment network user identifier.

18. The apparatus of claim 11, wherein the authentication circuitry is further configured to:
authenticate credential data received from a customer device associated with the second digital payment network user identifier.

19. The apparatus of claim 11, wherein the tax operation indicator identifies the cost amount identifier as identifying a cost amount as one of a pre-tax cost amount or a post-tax cost amount.

20. A computer program product comprising at least one non-transitory computer-readable storage medium storing software instructions that, when executed, cause an apparatus to:
receive a digital transaction request for a transaction, wherein the digital transaction request is associated with a digital payment network and comprises a first digital payment network user identifier associated with a business, a second digital payment network user identifier associated with a customer, one or more product identifiers, a tax operation indicator, and a cost amount identifier;
determine a purchase amount and a tax amount based on the cost amount identifier;
generate a modified digital transaction request based on the purchase amount;
authenticate the modified digital transaction request; and
in response to a successful authentication of the modified digital transaction request:
identify one or more target recipient accounts based on the modified digital transaction request, and
automatically cause, based on the modified digital transaction request, at least one transfer of funds to at least one target recipient account of the one or more target recipient accounts.
